(19) United States
(12) Patent Application Publication
(10) Pub. No.: US 2009/0094131 A1
(43) Pub. Date: Apr. 9, 2009

(54) System and method for customer delivery notification

(76) Inventor: Matt Diamond, Austin, TX (US)

Correspondence Address: HAMILTON & TERRILE, LLP, P.O. BOX 203518, AUSTIN, TX, 78720, US

(21) Appl. No.: 11/867,737

(22) Filed: Oct. 5, 2007

(51) Int. Cl. G06Q 90/00

(52) U.S. Cl. 705/26

(57) ABSTRACT

Build-to-order products are shipped to consumers through plural shipping providers by giving the consumer an estimated delivery date for the arrival of the product at the consumer delivery address. Using an estimated delivery date makes the notice agnostic of the shipping provider so that multiple transport means may be used to ship the product.

### BACKGROUND OF THE INVENTION

1. Field of the Invention

The present invention relates in general to the field of delivery of products to consumers, and more particularly to a system and method for customer delivery notification of information handling system delivery.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems have tremendous flexibility to adapt to a variety of functions because information handling systems are built from a wide variety of components having a wide range of capabilities. Consumers who desire information handling systems for particular functions often purchase the information handling systems “built-to-order.” An information handling system that is built to order is built based on a configuration of components selected by an end user who purchases the system. For example, a purchaser interacts with a manufacturer through the Internet or a telephone sales representative. The purchaser selects a desired model and then selects components to populate the model, such as the type of processor, amount of memory, storage drives and software components like the operating system and applications. The manufacturer builds the information handling system to the order placed by the purchaser and then ships the information handling system to a destination designated by the manufacturer. The build-to-order process provides an improved purchaser experience by allowing the purchaser to balance the cost of an ordered system with the performance of the system needed by the system. The manufacturer benefits due to the improved purchaser experience plus cost savings from reduced inventory of components and built systems.

One difficulty with the build-to-order process is the shipment of the built information handling system to the correct purchaser at the correct location in a timely manner. In some cases, enterprises who order large numbers of information handling systems arrange for their own shipments using their own shipping contract. In other cases, the information handling system manufacturer will contract with a shipping provider to ship the package to the end user. Typically, shipment of information handling systems requires a signature by a receiving party to verify the delivery. Deliveries to business customers generally do not present a significant challenge since most businesses have a receptionist or other employee on hand to accept delivery. In contrast, delivery to individual consumers at their residences can present a challenge since individual consumers are often not home during normal delivery hours. Unsuccessful delivery attempts increase shipping costs since the shipping provider must redeliver the package at a later date. When numerous delivery attempts are unsuccessful, the package may even be returned to the manufacturer. In some instances, the shipping provider will attempt to contact individuals at residences to arrange to have someone home that can accept the delivery. However, notice to a residence on the day of shipment is often ineffective since the individual does not have time to arrange to stay home. Advanced notice is sometimes difficult since more than one shipping provider may be involved in the shipment process.

### SUMMARY OF THE INVENTION

Therefore a need has arisen for a system and method which provides advanced delivery notification of a package to a consumer.

In accordance with the present invention, a system and method are provided which substantially reduce the disadvantages and problems associated with previous methods and systems for shipping products to consumers. An estimated delivery date is predicted for the product and used to provide advanced notice of delivery to the consumer. The estimated delivery date is calculated from the manifest used to coordinate manufacture of the product.

More specifically, a consumer orders an information handling system from a manufacturer by specifying the configuration for the information handling system and a delivery address to which the information handling system should be shipped. Upon completion of manufacture of the information handling system, an estimated delivery date for delivery of the information handling system to the consumer is calculated based upon the manifest for the information handling system. The consumer is provided with notice of the estimated delivery date so that the consumer is prepared to accept delivery of the shipment on the estimated delivery date. Actual shipment of the information handling system may proceed through multiple different shipping providers, such as truckload shippers, less than truckload shippers or parcel shippers.

The present invention provides a number of important technical advantages. One example of an important technical advantage is that a consumer is provided with advanced delivery notification for packages sent to the consumer based on predicted versus actual shipping information. The use of predicted shipping information provides advanced notification for the time of delivery even where multiple shipping providers and multiple shipping methods are involved in the delivery. Delivery notification based on predicted shipping information leaves control of customer notification to the manufacturer rather than the shipper so the manufacturer is better able to manage the customer experience in the delivery process.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of a system for managing information handling system deliveries based on predicted delivery dates; and

FIG. 2 depicts a flow diagram of a method for managing information handling system deliveries based on predicted delivery dates.

### DETAILED DESCRIPTION

Customer notification of an information handling system delivery based on a predicted delivery date allows advanced notice that is agnostic of the carrier and transportation modes used to make the delivery. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

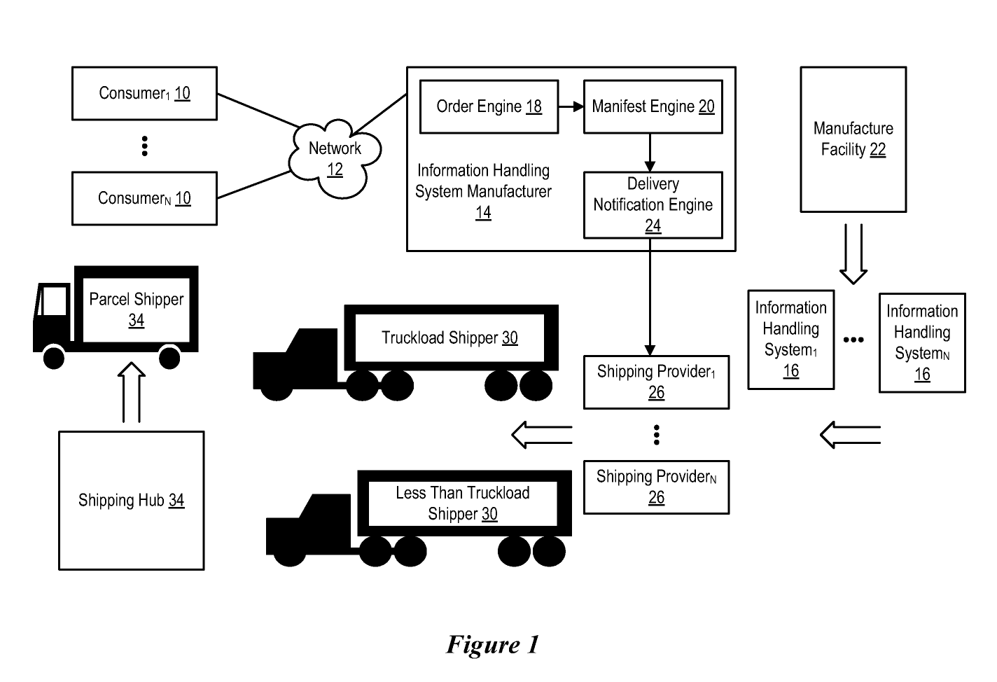

Referring now to FIG. 1, a block diagram depicts a system for managing information handling system deliveries based on predicted delivery dates. Consumers 10 interface through a network 12, such as the Internet or POTS, to place orders for information handling systems 16 with an information handling system manufacturer 14. For example, consumers 10 are provided with an order form by an order engine 18 that allows the consumer 10 to specify the configuration of an information handling system 16 and a delivery location to which the completed system is to be shipped. Configurations specified by a consumer 10 might include hardware components for the information handling system 16, such as the CPU, amount of RAM or size of hard disk drive storage, or might include software components, such as the operating system and applications loaded on the information handling system 16. Once an order is complete, order engine 18 provides the order information to a manifest engine 20 that generates a manifest to coordinate the manufacture and delivery of the built-to-order information handling system 16. The manifest is communicated to a manufacture facility 22 that applies the manifest to build the information handling system 16 from the components selected by the consumer 10.

In addition to providing a manifest to manufacture facility 22, manifest engine 20 also provides the manifest to a delivery notification engine 24. Delivery notification engine 24 applies the configuration and delivery information to predict a delivery date for the information handling system to the delivery address input by the consumer 10. For instance, the delivery date is predicted based on delivery information provided by the shipping providers 26 involved in the shipment delivery and historical shipping results. Delivery notification engine 24 provides the predicted delivery date to the shipping provider upon completion of the information handling system 16, such as when the information handling system 16 is provided to the shipping provider 16 for delivery to the consumer 10. The predicted delivery date is forwarded to the consumer 10 by the shipping provider 26 or, alternatively, by information handling system manufacturer 14. Notification to the consumer 10 of the predicted delivery date allows sufficient warning time for the consumer 10 to arrange to have someone home to sign for the shipment delivery.

One advantage of notification with a predicted delivery date is that the information handling system manufacturer 14 may use multiple combinations of shipping options for delivery of the shipment with reduced cost. For example, a less than truckload shipper 28 or a truckload shipper 30 having reduced shipment costs might bring the shipment to a shipping hub 32 so that final delivery is accomplished by a parcel shipper 34. En route, parcel shipper 34 can adjust delivery so that actual delivery occurs on the predicted delivery date. Although the embodiment depicted by FIG. 1 relates to delivery of information handling systems, in alternative embodiments, other types of products might be delivered instead of information handling systems.

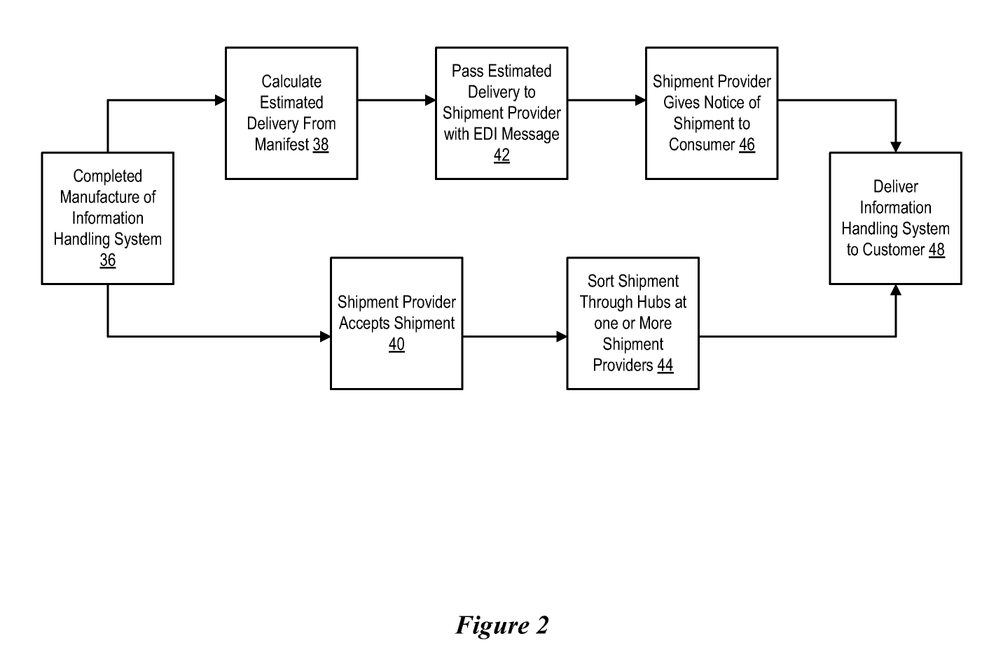

Referring now to FIG. 2, a flow diagram depicts a method for managing information handling system deliveries based on predicted delivery dates. The process begins at step 36 with completion of manufacture of an information handling system. At step 38, an estimated delivery date is calculated from the manifest by applying manifest information, such as the configuration and delivery address. At step 40, the shipping provider physically accepts the shipment. At step 42, the estimated delivery date for the shipment is sent to the shipping provider, such as with an EDI message. At step 44, the shipment passes through the shipping process, such as through shipping hubs for plural shipping providers. As the shipment proceeds to the consumer, at step 46 the shipment provider gives notice to the consumer of the estimated delivery date for the shipment. For example, the estimated delivery date is communicated by telephone, e-mail or other communication preference made by the consumer. The information handling system is delivered at step 48 on the estimated delivery date so that the consumer has notice to have someone at the delivery address to accept the shipment.

Although the present invention has been described in detail, it should be understood that various changes, substitutions and alterations can be made hereto without departing from the spirit and scope of the invention as defined by the appended claims.

What is claimed is:

1. A system for shipping a product from a manufacturer to a consumer, the system comprising:
an order engine operable to accept orders to build products, each product having a configuration specified by a consumer;
a manifest engine interfaced with the order engine and operable to define a manifest having manufacture and delivery instructions for each product; and
a delivery notification engine interfaced with the manifest engine, the delivery notification engine operable to apply the manifest to predict a delivery date associated with the product and to communicate the delivery date to one or more predetermined recipients.

2. The system of claim 1 wherein the delivery instructions comprises shipment by plural shipping providers.

3. The system of claim 2 wherein the plural shipping providers comprise a parcel shipper.

4. The system of claim 3 wherein the plural shipping providers comprise a truckload shipper.

5. The system of claim 3 wherein the plural shipping providers comprise a less than truckload shipper.

6. The system of claim 1 wherein the product comprises an information handling system.

7. The system of claim 1 wherein the recipient comprises the product consumer.

8. The system of claim 1 wherein the recipient comprises the shipping provider.

9. A method for shipping a product from a manufacturer to a consumer, the method comprising:
accepting product orders from consumers, each product having a configuration selected by an associated consumer;
generating a manifest for each product order, each manifest having manufacture and delivery instructions for an associated order;
applying the manifest to predict a delivery date for each product; and
communicating the delivery date to one or more recipients.

10. The method of claim 9 further comprising shipping at least one product through plural shipping providers.

11. The method of claim 10 wherein the plural shipping providers comprise a parcel shipper.

12. The method of claim 11 wherein the plural shipping providers comprise a truckload shipper.

13. The method of claim 11 wherein the plural shipping providers comprise a less than truckload shipper.

14. The method of claim 9 further comprising building information handling system products to order.

15. The method of claim 9 wherein communicating the delivery date further comprises communicating the deliver date to the consumer.

16. The method of claim 9 wherein communicating the delivery date further comprises communicating the delivery date to a shipping provider.

17. A system for shipping built-to-order information handling systems, the system comprising:
a manifest engine operable to generate a manifest having the configuration of the information handling system and a delivery address for the information handling system; and
a delivery notification engine interfaced with the manifest engine and operable to apply the manifest to predict a delivery time for the information handling system at the delivery address and to communicate the delivery time to one or more recipients.

18. The system of claim 17 wherein the delivery notification engine is further operable to predict the delivery time with shipment of the information handling system by plural shipping providers.

19. The system of claim 18 wherein the plural shipping providers comprise a parcel shipper and a truckload shipper.

20. The system of claim 18 wherein the plural shipping providers comprise a parcel shipper and a less that truckload shipper.
